(19) United States
(12) Patent Application Publication
(10) Pub. No.: US 2006/0290933 A1
(43) Pub. Date: Dec. 28, 2006

(54) System and method for monitoring plant conditions

(76) Inventor: Paige Holm, Phoenix, AZ (US)

Correspondence Address: MOTOROLA, INC., 1303 EAST ALGONQUIN ROAD, IL01/3RD, SCHAUMBURG, IL, 60196, US

(21) Appl. No.: 11/167,475

(22) Filed: Jun. 27, 2005

(51) Int. Cl. G01N 21/25; G01J 3/50

(52) U.S. Cl. 356/416

(57) ABSTRACT

A system and method of monitoring plant conditions is disclosed where an optical element is enabled to collect incident light reflected from a plant, an optical bandpass filter is enabled to eliminate wavelengths of the incident light outside a plurality of desired spectral bands, and a spectrum capture element is enabled to capture the plurality of desired spectral bands, wherein the optical element, the optical bandpass filter, and the spectrum capture element operate to monitor plant conditions.

### FIELD OF INVENTION

The present invention relates generally to precision agriculture in particular to the field of monitoring plant conditions.

### BACKGROUND OF THE INVENTION

Precision agriculture is a systematic approach toward high efficiency, environmentally sensitive farming. Precision agriculture stresses the minimal use of agrochemicals for fertilization, pest and weed control and is a response to public ecological concerns. Further, precision agriculture utilizes the latest technological advances in the areas of global positioning and information systems, in-field and remote sensing, portable computing and information processing, and wireless communications systems to sense and manage spatial and temporal variability in agricultural fields to allow a more defined and optimal strategy for farming practices.

An area of precision agriculture that facilitates the collection of plant data is Hyperspectral Imaging (HSI). HSI involves narrowband spectral analysis of vegetation and involves capturing a series of images of crops from high altitudes, typically from a satellite or an airplane. With HSI each image is acquired within narrowband, adjacent slices of the visible to near infrared (NIR) spectrum.

Although HIS facilitates the collection of plant data, HIS suffers from various disadvantages. First, HSI generates an enormous volume of data. Second, much of the data is extraneous and therefore requires post-collection analysis. Third, much of the data requires some sort of pre-processing before the data is utilized. Fourth, HSI is not considered reliable as it is subject to changes in weather and atmospheric conditions. Fifth, since the images are taken from a distance, the images are often distorted leading to misrepresentation and misleading data of plant conditions. Finally, HIS is costly to implement.

Accordingly, there exists a need for a new system and method for monitoring plant conditions.

### BRIEF DESCRIPTION OF THE DIAGRAMS

The accompanying figures together with the detailed description below are incorporated in and form part of the specification, serve to further illustrate various embodiments and to explain various principles and advantages all in accordance with the present invention.

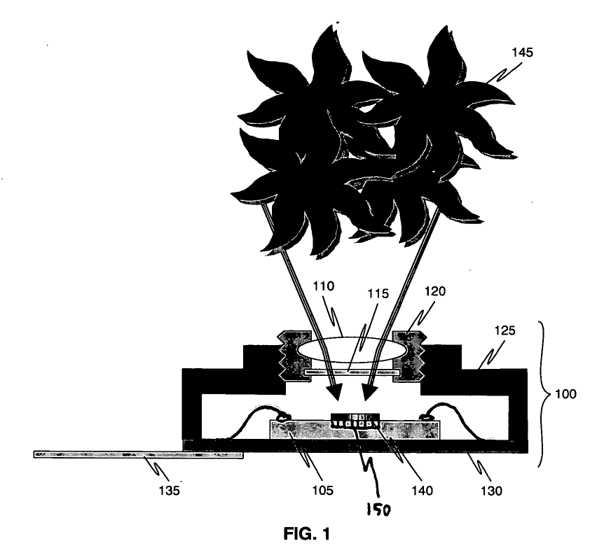

FIG. 1 depicts a sensor to monitor plant conditions in accordance with an embodiment of the invention.

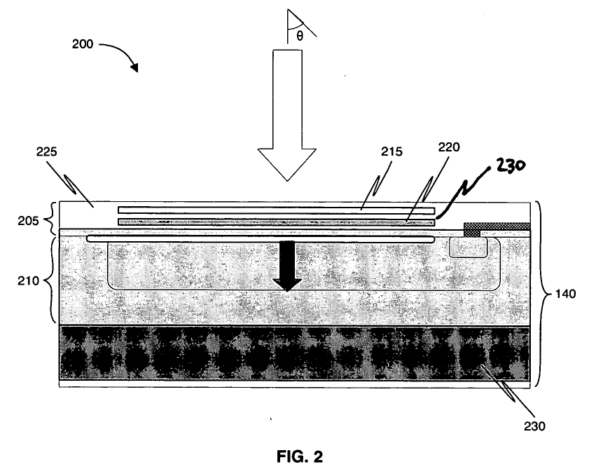

FIG. 2 denotes a spectrum capture element in accordance with an embodiment of the invention.

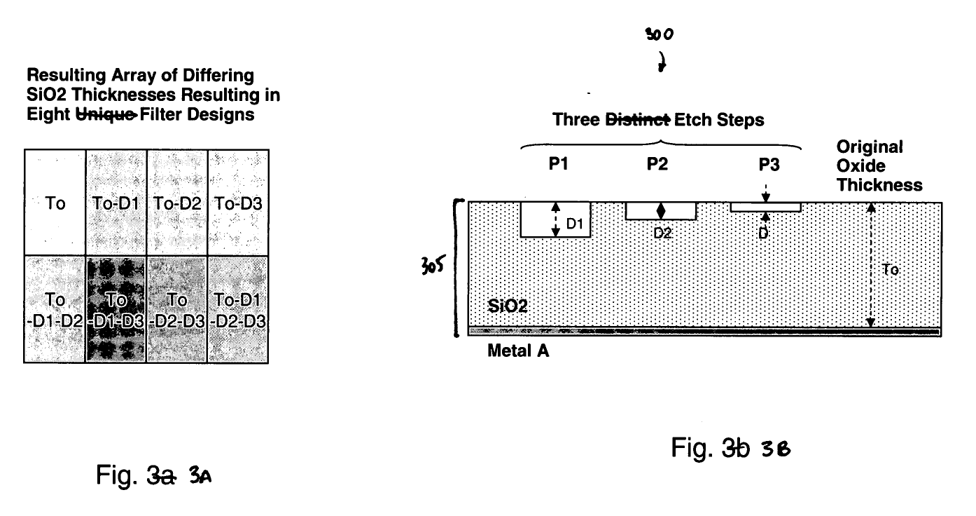

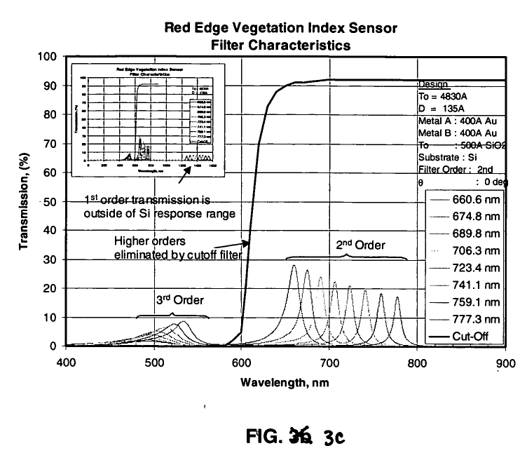

FIG. 3A depicts an embodiment of fabrication of an array of optical filters in the spectrum capture element in accordance with an embodiment of the invention.

FIG. 3B depicts an embodiment of the array of optical filters in the spectrum capture element in accordance with an embodiment of the invention.

FIG. 3C depicts characteristics of a red-edge sensor in accordance with an embodiment of the invention.

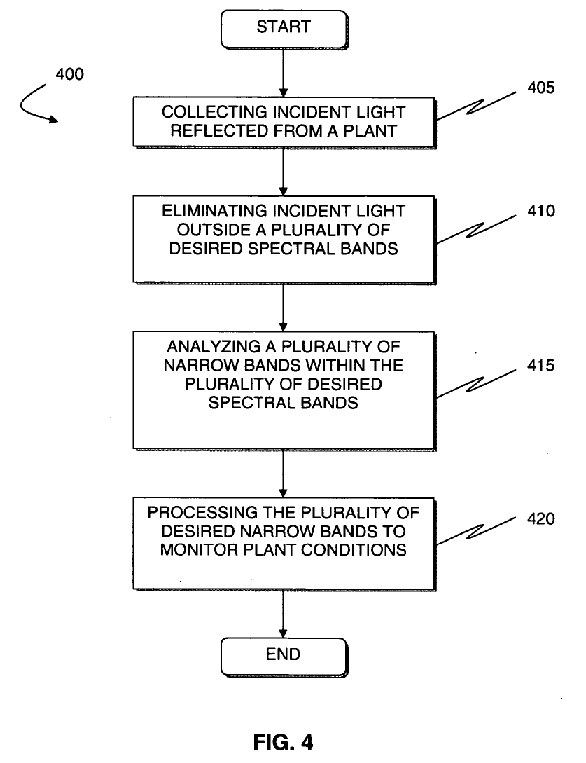

FIG. 4 shows a flowchart of a method of monitoring plant conditions in accordance with an embodiment of the invention.

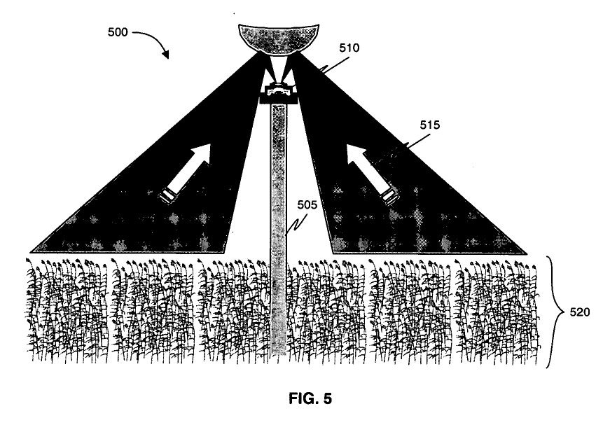

FIG. 5 shows a system for monitoring plant conditions in accordance with an embodiment of the invention.

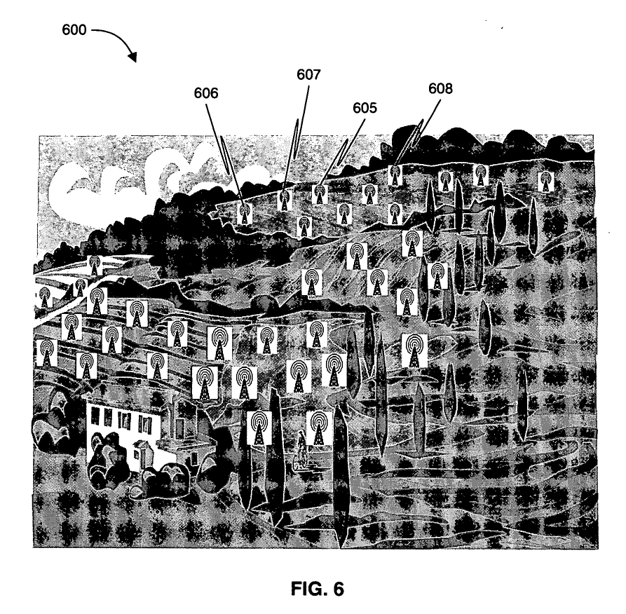

FIG. 6 depicts a plurality of sensing nodes, each of which are deployed in an agricultural area in accordance with an embodiment of the invention.

### DETAILED DESCRIPTION OF THE INVENTION

The present invention may be embodied in several forms and manners. The description provided below and the drawings show exemplary embodiments of the invention. Those of skill in the art will appreciate that the invention may be embodied in other forms and manners not shown below. The invention shall have the full scope of the claims and shall not be limited by the embodiments shown below. It is further understood that the use of relational term, if any, such as first, second, top and bottom, front and rear and the like are used solely for distinguishing one entity or action from another, without necessarily requiring or implying any such actual relationship or order between such entities or actions.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that monitoring plant conditions described herein may be comprised of one or more conventional processors and unique stored program instructions that control the one or more processors to implement, in conjunction with certain non-processor circuits, some, most, or all of the functions of the method for interpreting user input in an electronic device described herein. The non-processor circuits may include, but are not limited to, a radio receiver, a radio transmitter, signal drivers, clock circuits, power source circuits, and user input devices. As such, these functions may be interpreted as steps of a method to perform monitoring plant conditions. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

FIG. 1 depicts a sensor 100 to monitor plant conditions in accordance with an embodiment of the invention. The sensor 100 comprises an optical element 110, an optical bandpass filter 115, and a spectrum capture element 105, wherein the optical element, the optical bandpass filter, and the spectrum capture element operate to monitor plant conditions. In a further embodiment, the sensor 100 further comprises a casing 125 for enclosing the optical element 110, the optical bandpass filter 115, and the spectrum capture element 105. In any case, the sensor 100 analyzes incident light in a plurality of desired spectral bands to determine plant conditions. As used herein, plant conditions is defined as information relating to plant vital signs, such as foliage water, chlorophyll content, nutrient availability, level of photosynthetic activity, efficiency of photosynthetic activity, and the like. In one embodiment, information about plant conditions is at least one vegetation index.

In one embodiment, the optical element 110 collects a plurality of desired spectral bands from incident light where the incident light has been reflected from a plant 145. As used herein, desired is defined as spectral bands that are within a range. For example, if “red edge” spectral analysis is of interest, then desired spectral bands may be in the range of 650 nm to 800 nm. Other desired spectral bands (e.g. visible, near visible, infra-red, and near infra-red) may be of interest and are not further described herein. Continuing, the optical element 110 also limits the numerical aperture (NA) of the light incident in the spectrum capture element 105 of the sensor 100. As examples, exemplary NAs for the optical element 110 are between 0.02 and 0.025.

Coupled to the optical element 110 is the optical bandpass filter 115 where the optical bandpass filter further eliminates unwanted spectral band that has been collected by the optical element 110. That is, the optical bandpass filter 115 filters out wavelengths of incident radiation outside the plurality of desired spectral bands. Thus, using an optical bandpass filter 115 reduces out-of-band noise components. Further, using an optical bandpass filter 115 reduces the volume of spectral data that needs to be further processed. Thus, addressing one of the problems of the prior art.

In one embodiment, a lens holder 120 holds the optical element 110, and the optical bandpass filter 115 to facilitate proper alignment between the optical bandpass filter 115 and the optical element 110. As is known in the art, the lens holder 120 may be an adjustable lens holder that can be used to adjust the focus of the incident light onto the optical element 110. In an exemplary embodiment, the lens holder 120 performs defocusing of the incident light so that an image is not achieved.

Continuing with FIG. 1, the collected plurality of desired spectral bands are captured by the spectrum capture element 105. The spectrum capture element 105 performs spectral decomposition of the captured desired spectral bands of the incident light to determine plant conditions. In one embodiment, the spectrum capture element 105 is a fabricated chip. In any case, the spectrum capture element 105 further comprises an array of optical filters 140 and an array of detectors 150. Each optical filter of the array of optical filters 140 performs spectral decomposition of the collected plurality of desired spectral bands. In one embodiment, each optical filter may be a narrowband pass optical filter. Further, the array of narrowband filters 140 resides in the optical path of the collected plurality of desired spectral bands and resides above the array of detectors 150. In one embodiment, each detector in the array of detectors 150 is a silicon photodiode detector.

As mentioned above, in one embodiment, the casing 125 encloses the optical element 110, the optical bandpass filter 115, and the spectrum capture element 105 to shield them from any external noise or conditions. In an alternative embodiment, the casing also enclosed the lens holder 120, along with the optical element 110, the optical bandpass filter 115, and the spectrum capture element 105. In any case, the casing 125 may be an inexpensive plastic housing.

In an alternative embodiment, the sensor comprises a circuit board 130. The circuit board 130 provides the ability to transfer information about plant conditions to an external system, such as a computing system (not shown). In one embodiment of the alternative, the circuit board 130 carries a plurality of signals generated at the spectrum capture element and transfers the signals to the external system by a ribbon cable connector 135. The external system may be responsible for generating analysis of the plant conditions so as to facilitate precision agriculture.

In an embodiment, the optical element 110 comprises at least one of a conventional lens, a fiber optic cable, a bifurcated fiber bundle and a fiber optic faceplate that can be integrated into the spectrum capture element. In any case, the optical element 110 limits the numerical aperture (as mentioned above) where the numerical aperture may be defined according to a performance standard that defines the spectral width of the plurality of desired spectral bands.

In one embodiment, the plurality of desired spectral bands may be determined by one or more vegetation indexes where desired is defined by the one or more vegetation indexes. As is known in the art, a vegetation index may comprise a simple ratio or a normalized signal difference at two critical wavelengths. Further, a vegetation index may be defined as a complex function of signals or a combination of a plurality of simple indices. A vegetation index could further be extracted with a measurement of a limited number of discrete wavelength bands and may not require a dense scan of reflected spectrum from a sensor, e.g. sensor 100. A vast majority of vegetation indices are determined from measurements in a visible and near infra-red range, thereby allowing the use of silicon based photodiode detectors as a transduction element. In addition, additional vegetation indices include a Normalized Differential Vegetation Index, a Renormalized Difference Vegetation Index, a Modified Simple Ratio, a Soil-Adjusted Vegetation Index, a Improved Soil-Adjusted Vegetation Index, a Soil and Atmospherically Resistance Vegetation Index, a Modified Chlorophyll Absorption Ratio Index, a Triangular Vegetation Index, a Photochemical Reflectance Index, a Red Edge Position, a Slope at Red Edge, a Leaf Chlorophyll Index, a Water Index, a Normalized Difference Water Index, and a Clay Index. In any case, such indices determine desired spectral band for the sensor 100.

In one embodiment, the optical bandpass filter 115 may be integrated with the spectrum capture element 105. In such an embodiment, the optical bandpass filter 115 may be integrated with the array of optical filters 140 on the spectrum capture element 115. Integrating the optical bandpass filter 115 with the spectrum capture element 115 may make the sensor 100 compact and may provide better elimination of wavelengths of incident light outside the plurality of desired spectral band. In any case, the optical bandpass filter 115 can be a longpass edge filter or a shortpass edge filter. In the embodiment of the long pass edge filter, wavelengths above a specified wavelength are transmitted, whereas in the embodiment of the short pass filter, wavelengths that are less than a specified wavelength are transmitted. In any case, the optical bandpass filter 115 can comprise a multi-layer dielectric stack and may be a discrete (non-integrated) filter.

Referring now to FIG. 2, a spectrum capture element 200 (also referred to as 105 in FIG. 1) in accordance with an embodiment of the invention is shown. In an embodiment of the invention, the spectrum capture element is a fabricated chip. In any case, the spectrum capture element 200 comprises an array of optical filters 205 coupled to an array of detectors 210 to perform spectral decomposition of the captured desired spectral bands of the incident light to determine plant conditions (as mentioned above).

In one embodiment, each optical filter in the array of optical filters 205 is a narrowband pass optical filter where the narrowband pass optical filter is fabricated to form a part of the array of optical filters 205. Each optical filter has a pass-band that is tuned to a particular wavelength and aligned to a desired spectral band. As mentioned above, there is a correlation between desired spectral bands and vegetation indices. In any case, the pass-band may be less than 50 nm. In a preferred embodiment of the invention, the pass-band of the optical filter may be between 10 nm and 20 nm. In an embodiment of the invention, the array of optical filters 205 can comprise a Fabry-Perot resonator. The Fabry-Perot resonator can comprise a pair of semi-transparent metal films (215, 220) separated by a dielectric material 230. A thickness of the dielectric material 230 may be adjusted to approximately one half of a wavelength of a desired transmission peak in a desired spectral band and/or multiples of the one-half wavelength where the multiples provide higher order filter operation. In one embodiment, the dielectric material 230 is a made of silicon dioxide. In one embodiment, the pair of semi-transparent metal films (215, 220) can be made of gold, silver, aluminum or a combination thereof.

In one embodiment, each detector in the array of the detectors 210 is a photodiode detector. The array of detectors 210 comprise a plurality of silicon p-n junction photodiode fabricated within a silicon substrate 230. In an embodiment, the spectrum capture element 200 may also contain complementary metal oxide semiconductor (CMOS) electronics for interfacing the array of detectors 210 to other higher-level functions.

In any case, the spectrum capture element 200 performs spectral decomposition of the captured desired spectral bands of the incident light to determine plant conditions. In one embodiment, the desired spectral bands correlate to a vegetation index where the vegetation index is defined by wavelengths in a spectral band.

For example, a spectrum capture element 200 implemented to analyze a “red edge” occurring in a range of 650 nm to 800 nm of the spectrum comprises an array of Fabry-Perot resonant filters (e.g. 205) over an array of silicon p-n junction diodes. In such an embodiment, the “red edge” helps in providing vital information on plant conditions. The plurality of Fabry-Perot resonant filters have distinct, but adjacent passbands spanning over the red edge region of the spectrum. In such an embodiment, in order to adequately cover the red edge spectral range of about 650 nm to 800 nm, approximately eight 15 nm wide bands may be required, and therefore eight different oxide layer thicknesses for a plurality of etalons of the Fabry-Perot filters. As shown in FIG. 3A, the eight different oxide layer thicknesses for the plurality of etalons may be realized using a plurality of possible combinations of three separate etch steps of varying depths into an original layer 305, as shown in FIG. 3B. As depicted in embodiment 300, the plurality of varying depths D1, D2 and D3 etched in the original layer 305 can produce different passbands, which facilitate the sensor 100 to capture a plurality of desired wavelengths. For example, for the red-edge embodiment, D1, D2, and D3 facilitate the sensor 100 to capture a plurality of desired wavelengths in the “red-edge.”

In the “red-edge” embodiment, the plurality of Fabry-Perot resonant filters can be designed for second order operation to maintain a narrow bandpass. As shown in FIG. 3C, a first order transmission may occur beyond the response range of the plurality of detectors which are comprised of silicon and cut out at around 1100 nm. A third and higher order filter response can be eliminated with a standard cutoff filter with an edge at about 600 nm. Thus, the “red-edge” embodiment operates to maintain a narrow bandpass operating within the spectral range of 650 nm to 800 nm. In another embodiment of the invention, a first order filter design may be implemented to provide greater fabrication tolerance as the values of D1, D2, and D3 increase substantially, but at the expense of even larger passband widths.

In another embodiment, the spectrum capture element 105 further comprises an interface enabled to provide array readout, signal conditioning and processing, analog to digital (A to D) conversion, and vegetation index computation. In yet another embodiment, the sensor 100, as described above, can form a part of a system for monitoring plant conditions using a wireless communications network.

FIG. 4 shows a flowchart of an embodiment of a method of monitoring plant conditions. The method comprises, at step 405, collecting incident light reflected from a plant e.g. using the optical element 110 in a sensor 100 (as described above). This incident light contains spectral components outside of the plurality of desired spectral bands that constitute a spectral noise component. At step 410, the method comprises eliminating the incident light that is outside a plurality of desired spectral bands, e.g. by guiding the incident light that has been reflected from a plant through an optical bandpass filter 115 in order to eliminate the spectral noise. Eliminating the spectral noise aids in enabling the sensor to selectively process the plurality of desired spectral bands and produce relevant and reliable information about plant conditions. In one embodiment, information about plant conditions comprises at least one vegetation index. As stated earlier, a vegetation index comprises ratios, or other simple mathematical relationships, of measured reflectance at various wavelengths. The method further comprises, at step 415, analyzing a plurality of narrow bands within the plurality of desired spectral bands within the spectrum of incident light. In one embodiment, analyzing a plurality of narrow bands within the plurality of desired spectral bands is performed by segregating the spectrum of incident light into a plurality of desired spectral bands using an array of optical filters coupled to an array of detectors in a sensor. The method further comprises, at step 420, processing the plurality of narrow bands to monitor plant conditions. In one embodiment, the method further comprises reading signals corresponding to the plurality of desired spectral bands, and processing the signals to obtain information about plant conditions. Information about plant conditions is further used in at least one farming procedure, e.g. the farming procedure can be either applying fertilizer or pesticide to the crop, harvesting, sowing, watering, or cultivating.

In a further embodiment, the method further comprises, communicating information about plant conditions wirelessly, e.g. in a wireless communications network. In such an embodiment, communicating wirelessly may involve the use of a plurality of sensing nodes as described with reference to FIG. 6 and described below. In such an embodiment, the wireless communication network may be one of a General Packet Radio Service (GPRS) network, a Global System for Mobile communications (GSM) network and a Code-Division Multiple Access (CDMA) network, a Wi-Fi network, a Wimax network, a Zigbee network. In such an embodiment, the information about plant conditions may be transmitted to a data acquisition unit in the wireless communication network where the information may be collected and managed. Further, the information about plant conditions may be utilized in at least one farming procedure; e.g. applying fertilizer or pesticide to the crop, harvesting, sowing, watering, or cultivating.

FIG. 5 illustrates an embodiment 500 of a system for collecting and utilizing information about plant conditions. The system comprises at least one sensing node or pole 505, which is mounted in a field and is able to capture a plurality of desired spectral bands from incident light where the incident light has been reflected 515 from the surrounding vegetation 520 through a sensor 510 in the sensing node 505. The sensing node 505 is enabled to capture the incident light that has been reflected 515, and provide information about plant conditions based on the plurality of desired spectral bands and communicate with a plurality of other sensing nodes through a mobile communications network. According to another embodiment 600 shown in FIG. 6, a first sensing node 605 is enabled to provide information about plant conditions in its vicinity and communicate with a plurality of sensing nodes (for example, 606, 607, 608) in the neighboring area through the use of a wireless communications network. Thus, an agricultural field can include a plurality of sensing nodes (for example 605, 606, 607, 608), each of which can be enabled to provide information about plant conditions from its own vicinity and communicate the information about plant conditions through the use of the wireless communication communications network. Alternatively, each sensing node can be a stand-alone node, deployed in a garden or smaller plot area, where it provides information about plant conditions. In one embodiment, the information about plant conditions is related to one or more vegetation indexes. In one embodiment, the wireless communication network comprises at least one of a General Packet Radio Service network (GPRS), a Global System for Mobile communication network (GSM) and a Code-Division Multiple Access network (CDMA), a Wi-Fi network, a Wimax network, a Zigbee network.

The sensing node comprises at least one sensor 100 to provide information about plant conditions, and a microcontroller (not shown) to analyze the information about plant conditions. The sensor 100 is described earlier in this application.

This disclosure is intended to explain how to fashion and use various embodiments in accordance with the invention rather than to limit the true, intended and fair scope and spirit thereof. The foregoing discussion is not intended to be exhaustive or to limit the invention to the precise forms disclosed. Modifications or variations are possible in the light of the above teachings. The embodiment(s) was chosen and described to provide the best illustration of the principles of the invention and practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally and equitably entitled.

What is claimed is:

1. A sensor for monitoring plant conditions, comprising:
an optical element enabled to collect incident light reflected from a plant;
an optical bandpass filter enabled to eliminate wavelengths of the incident light outside a plurality of desired spectral bands; and
a spectrum capture element enabled to capture the plurality of desired spectral bands,
wherein the optical element, the optical bandpass filter, and the spectrum capture element operate to monitor plant conditions.

2. The sensor of claim 1 further comprising a casing enclosing the optical element, the optical bandpass filter, and the spectrum capture element.

3. The sensor of claim 1 further comprising a lens holder to hold the optical element and the optical bandpass filter.

4. The sensor of claim 1, wherein the spectrum capture element further comprises an array of optical filters coupled to an array of detectors.

5. The sensor of claim 4, wherein the array of optical filters comprises a Fabry-Perot resonator, wherein the Fabry-Perot resonator comprises a pair of semi-transparent metal films separated by a dielectric material.

6. The sensor of claim 4, wherein the optical bandpass filter is integrated with the array of optical filters on the spectrum capture element.

7. The sensor of claim 4, wherein the optical bandpass filter comprises at least one of a longpass edge filter and a shortpass edge filter.

8. The sensor of claim 1, wherein the plurality of desired spectral bands is determined by one or more vegetation indexes.

9. The sensor of claim 1, wherein the optical element is enabled to limit a numerical aperture of the incident light.

10. The sensor of claim 1, wherein the optical element comprises at least one of a conventional lens, a fiber optic cable, a bifurcated fiber bundle and a fiber optic faceplate that can be integrated into the spectrum capture element.

11. The sensor of claim 1, further comprising a circuit board for communicating with an external system.

12. A system for monitoring plant conditions, comprising:
a first sensing node enabled to generate information about plant conditions and to communicate the information with at least a second sensing node through a wireless communications network,
wherein the plant conditions is related to one or more vegetation indexes.

13. The system of claim 12, wherein the first sensing node comprises at least one sensor enabled to generate the information about plant conditions.

14. The system of claim 12, wherein the first sensing node further comprises a device for harvesting energy from the node environment.

15. The system of claim 12, wherein the wireless communication network comprises at least one of a General Packet Radio Service network, a Global System for Mobile communication network and a Code-Division Multiple Access network, a Wi-Fi network, a Wimax network, a Zigbee network.

16. A method of monitoring plant conditions comprising:
collecting incident light reflected from a plant;
eliminating incident light outside a plurality of desired spectral bands, analyzing a plurality of narrow bands within the plurality of desired spectral bands; and
processing the plurality of narrow bands to monitor plant conditions.

17. The method of claim 16, wherein the processing step further comprises:
reading signals corresponding to the plurality of desired spectral bands; and
processing the signals to provide information about the plant conditions.

18. The method of claim 16, wherein the plant conditions comprise at least one vegetation index.

19. The method of claim 16 wherein information about plant conditions is communicated in a wireless communication network

20. The method of claim 19, wherein the communicating step further comprises:
forwarding the information about plant conditions to a data acquisition unit in the wireless communication network.
